(19) United States
(12) Patent Application Publication
(10) Pub. No.: US 2003/0026598 A1
(43) Pub. Date: Feb. 6, 2003

(54) Optical disc recorded media adapted to play back on both DVD players and personal computers and method for creating same

(76) Inventor: Shogo Karitani, San Jose, CA (US)

Correspondence Address: MCKEE, VOORHEES & SEASE, P.L.C., 801 GRAND AVENUE, SUITE 3200, DES MOINES, IA, 50309-2721, US

(21) Appl. No.: 10/208,914

(22) Filed: Jul. 30, 2002

Related U.S. Application Data
(60) Provisional application No. 60/309,029, filed on Jul. 31, 2001.

(51) Int. Cl. H04N 5/781

(52) U.S. Cl. 386/125; 386/126

(57) ABSTRACT

An optical disc recorded media, and method of creating the same, that will play back on both DVD players and personal computers, comprising recorded formats having Video CD Segment Items displaced from the Video CD data track 1.

### REFERENCE TO RELATED APPLICATION

This application is related to and based on U.S. Provisional Application Serial No. 60/309,029.

### INCORPORATION BY REFERENCE

The entire contents of U.S. Provisional Application Serial No. 60/309,029 is incorporated by reference herein.

### BACKGROUND OF THE INVENTION

1. Field of the Invention

The present invention relates to Picture CDs and Video CDs. More particularly, the present invention relates to an optical disk recordable medium, one example being a CD, capable of containing both Picture CD and Video CD or Super Video CD information.

2. Problems in the Art

The Eastman Kodak Company provides for the developing of film onto Picture CDs. A Picture CD is a CD that contains both computer software for photoediting/photomanipulation and digital images of photos. The photoediting/photomanipulation software is stored on the first session of the CD. The first session is pre-pressed to avoid lengthy individual writing to create a Picture CD. The pictures are stored in the second session of the CD.

The pictures are stored as JPEG images. The Picture CD previously supported up to 40 images per CD, but now that has been extended so that a Picture CD can store up to 200 images. Where 35 mm film is scanned to create the images, the resolution is 1024×1536 pixels per image. Where Advanced Photo System film is scanned to create the images, the resolution is scanned at 864×1536 pixels per image.

Information about the technical specifications of the Picture CD is available from a variety of sources.

Because the Picture CD includes software, a computer user can open and manipulate images on the Picture CD with a computer. This allows people who prefer film cameras to take photographs that are relatively cheaply developed into digital images on Picture CDs.

Despite these advantages of the Picture CD format, there are problems. In particular, not everyone considers viewing digital images on the computer to be convenient. Further, Picture CD provides only support for Apple Macintosh and PC formats. It would be more useful to view images on a television.

On the other hand, CDs in what are called Video CD or Super Video CD format are viewable on a television. DVD players, Sony PlayStations 2s, and other devices allow viewing of one or both of these formats. These types are widely used and have a growing user base. Video CD is a Compact Disc format that stores video sequences and stereo sound in A/V tracks. An A/V track contains play items which can be video, audio, or still images with or without audio. The Video CD specifications (sometimes known as the “White Book”) are available from Philips Electronics, and are hereby incorporated by reference in their entirety.

Therefore it would be desirable to have a single CD that could be used both in a computer with the benefits and advantages of Picture CD as well as in Video CD and/or Super Vide CD format for viewing with a DVD player or similar device.

Attempts have been made at converging these technologies. Others have been able to modify the hardware of DVD players in order to accommodate reading the images from a Picture CD. For example, LSI Logic and C-Cube have developed a chipset for DVD players that allows DVD players to play images contained on a Picture CD.

There are problems with this solution though. First, only DVD players with the new chipset can play the Picture CDs. Current DVD hardware can not do so. Therefore, only those who obtain DVD players with the new chipset can play the Picture CDs. Further, not every DVD that will be manufactured will necessarily contain a chipset that permits the playing of Picture CDs. There is no universal solution, and users may not even know whether or not their particular DVD players will be able to play Picture CDs.

Therefore, problems remain in the art. It is a primary object, feature, or advantage of the present invention to provide a solution that allows DVD players to play Picture CDs, improving up the state of the art.

It is a further object, feature, or advantage of the present invention to provide a solution that does not require alteration of DVD hardware in order to accommodate Picture CDs.

It is a still further object, feature, or advantage of the present invention to provide a solution that permits portions of a Picture CD to be pre-pressed.

Another object, feature, or advantage of the present invention is to provide a solution that allows a DVD player to play Picture CDs while still being low in cost.

Yet another object, feature, or advantage of the present invention is to provide a universal and/or backwards compatible solution that allows a DVD player to play Picture CDs.

Other objects, features, or advantages of the present invention will become clear from that which follows.

### BRIEF SUMMARY OF THE INVENTION

The present invention provides for methods, systems, and apparatuses relating to Picture CDs and Video CDs. In particular, the present invention provides for creating an optical disc such as a CD that contains both Picture CD images and Video CD or Super Video CD images. The CD of the present invention thus can provide both the benefits of Picture CD, by allowing a computer to access the images and software as well as being able to be played back on a DVD player or other device capable of playing Video CD and/or Super Video CD images.

Further, according to the present invention, the Picture CD photo manipulation software can still be written to the CD by prepressing, so that the process of writing images to the CD is still relatively short in duration.

### BRIEF DESCRIPTION OF THE DRAWINGS

FIG. 1 is a diagram of a multi-session CD format.

FIG. 2 is a diagram of a first exemplary embodiment of a Picture Video CD recorded media format according the present invention.

FIG. 3 is a diagram of a second exemplary embodiment of a Picture Video CD recorded media format according the present invention.

FIG. 4 is a diagram of a third exemplary embodiment of a Picture Video CD recorded media format according the present invention.

FIG. 5 is a diagram of a fourth exemplary embodiment of a Picture Video CD recorded media format according the present invention.

### DETAILED DESCRIPTION OF EXEMPLARY EMBODIMENTS OF THE INVENTION

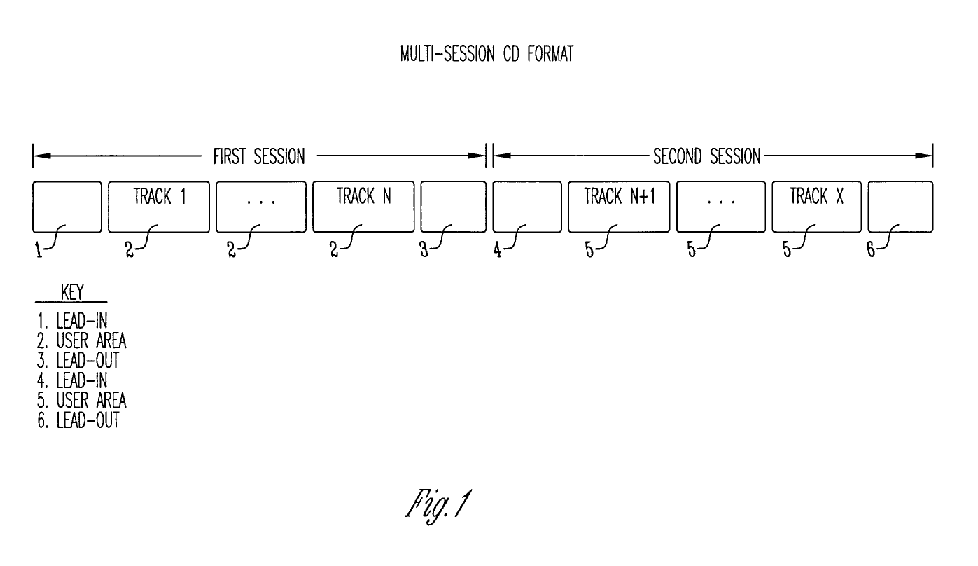

For purposes of explanation and discussion, the format of CDs and of Video CDs is briefly discussed. FIG. 1 illustrates some of these concepts in the context of multi-session CD's; where the CD can be written-to either in one session, or in multiple sessions, such as is well known in the art. In CDs, a lead-in area 1 is followed by a program area (see reference numerals 2), which is followed by a lead-out area 3. The program area contains user data. In Video CDs, the lead-in and lead-out areas 1 and 3 contain a series of empty CD-ROM/XA mode 2 Form 2 sectors. The lead-in area 1 also contains a number of subchannels, including subchannels P, Q, R, S, T, U, V, and W. Each subchannel contains different information. The main subchannels are P and Q. These subchannels contain control information, the CD's time code, and a Table of Contents (TOC) that provides a listing of the starting time of tracks so that each track can be directly accessed. A track is merely a data unit comprised of one unique sector format as defined by a particular specification. FIG. 1 also illustrates a multi-session disk format. A first session, having lead in area 1, a program area comprising a plurality of tracks 2 (labeled TRACK 1 to TRACK N, where N can vary), and a lead out area 3, could be followed by a second session similarly having a lead in area 4, a program area comprising a plurality of tracks 5 (TRACK N+1 to TRACK X, where X can vary), and a lead out area 6. A third session, or more, may be possible.

The present invention and Video CD use bridge discs. This specification combines green book (CD-i) tracks with red book (Audio CD) tracks or yellow book (CD-ROM data) tracks. In Video CD, the first track is a data track with an ISO 9660 file structure and can include other information for CD-i players. The subsequent tracks are MPEG-Audio-Video (MPEG AV) tracks, each possibly containing MPEG audio and video data. After the AV tracks, Red Book tracks may be used. These “books” are well known in the art and are published and available, and are incorporated by reference herein.

In a first track or TRACK 1 (reference number 2 of FIG. 1) of a conventional Video CD (or “VCD”) or Super Video CD (or “SVCD”) are a number of entries that include information known as “INFO.VCD”. This includes the Segment Play Item Area address. The Segment Play Items occupy one or more segments. The Segment Play Items are accessed indirectly through interpretation of the Play Sequence Descriptor (PSD) file. Normally, the Segment Play Items are within the first track. Segment Play Items are the MPEG1 (for Video CD) or MPEG2 (for Super Video CD) Intra-pictures to be displayed on TV.

In conventional VCD's or SVCD's, the Segment Play Item Area is usually contained in TRACK 1 (ref. no. 2 of FIG. 1), or in a track known as the DATA track, This TRACK 1 or DATA track can also include the file “INFO.VCD” in what is called the VCD or SVCD Information Area. Also, a VCD or SVCD directory contains the files from the Information Area. “INFO.VCD” is a mandatory file the VCD or SVCD directory.

In contrast, according to the present invention, however, the Segment Play Items are addressed to a location outside of the first track or TRACK 1 or DATA track such as illustrated at Ref. no. 2 of FIG. 1. This re-direction of the area pointer to outside of the first track allows the first track to be pre-pressed in the manner consistent with Picture CD, but still allowing pictures to be placed on the CD after the first track is pressed. In a sense, the Segment Play Items (the MPEG 1 or 2 format of the pictures), are displaced from their normal position (e.g. in TRACK 1) to a position outside of at least TRACK 1. In one embodiment, the Segment Play Items, the MPEG1 or MPEG Intra-pictures to be displayed on TV, can be placed outside of the pressed portion of the disc. Thus it enables the addition of end user pictures at a later time, but allows sufficient information to be pre-pressed on the disc for a DVD player to interpret and find the location of the Segment Play Items, even though they are not in their traditional position.

The segment play items can be MPEG1 Intra-pictures to be accessed by a DVD player or other device capable of Video CD. Alternatively the play items can be MPEG2 pictures in the case of Super Video CD. Either format can be used according to the present invention. In Super Video CD's, a Segment Play Item is defined as a MPEG-2 Program Stream (PS) stored in MPEG sectors. It may contain video, audio and still pictures conforming to MPEG 2 Program Stream coding. The Segment Play Item Area address is indicated in “INFO.VCD”. Segment Play Items (still, motion picture, or audio in segments of 150 sectors) are not accessed directly by the normal track playing mechanism, but indirectly by interpretation of the Play Sequence Descriptor file.

As the segment play items are addressed at a location outside of the first track, these items need not be present when the first track is written, or pre-pressed, provided that they are written to a known or predetermined location on the CD. This allows an end-user to add pictures to a subsequent track at a later time, therefore the advantages of Picture CD can be gained, while still providing Video CD format.

The present invention contemplates various alternative embodiments. The present invention is not, however, limited to those discussed, but these embodiments are merely representative of the improved methods that are achieved according to the present invention.

### EXAMPLE 1

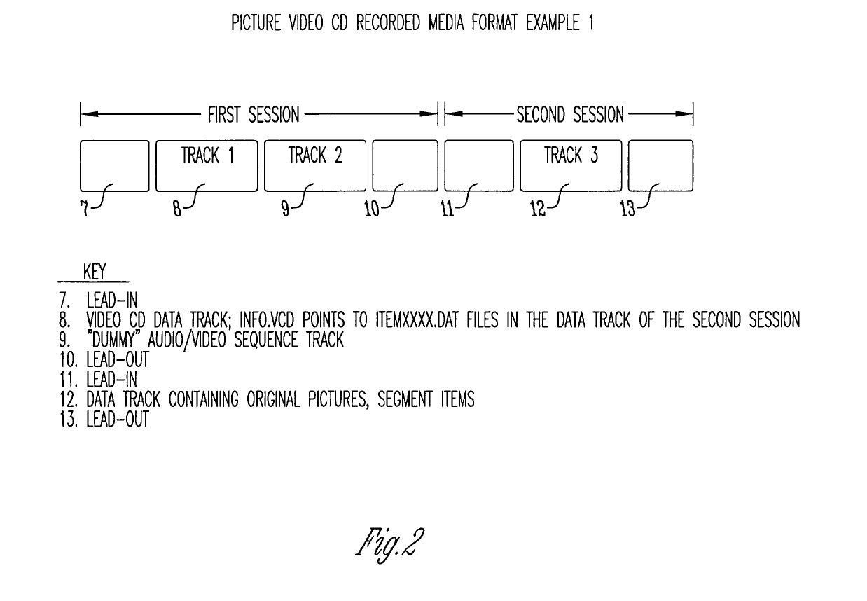

### FIG. 2

In a first embodiment, all of the required folders and files for Video CD are placed in the first session on a CD along with a Play Sequence Descriptor (PSD) for a pre-determined number of Segment Play Items. The First Segment Address in the INFO.VCD file is modified so that it points to the starting sector of ITEM0001.DAT file in the SEGMENT directory. All of the necessary files, including an auto-run file to execute a slide show on a PC, are then placed on the CD. For purposes of discussion, this group of files is called the pVCD engine.

A Picture CD master disc is then created through using Eastman Kodak's CD-PROM technology. Next, pre-determined ITEMxxxx.DAT files are placed in the first track of the second session of the CD. These files are placed in the beginning of the track, i.e., fixed locations relative to the first session. The location must be known or fixed as the Segment Play Item addresses are being defined in advance to point to these locations. Each of these .DAT files may occupy 150 Mode2 Form2 sectors. The original pictures are then placed in the first track of the second session. If the original pictures are less in number than the pre-determined number of pictures, “dummy” pictures are placed in the unfilled places. The “dummy” pictures are used so that all addresses given in the INFO.VCD file point to valid pictures. The “dummy” pictures can be a set of promotional pictures.

FIG. 2 illustrates this arrangement. In this method, session 1, a first track or TRACK 1 (see ref. no. 8, which follows a lead-in area 7) of the CD is an ISO 9660 XA CD-Bridge track that contains Picture CD files and the pVCD Engine. Session 1, TRACK 2 (see ref. no. 9 of FIG. 2) of the CD is merely a dummy AVSEQ track that is not used. Then the first session is closed, and a lead-out area 11 is created. This disc image is the image that can be pre-pressed or pre-written to the CD. For example, it can be pressed as Picture CD Volume xx Issue yy in accordance with Picture CD practice.

Next, session 2, in a first track for that session (i.e. a “track 1” for that session, here labeled TRACK 3 (ref. no. 12) to distinguish it from TRACK 1 (ref. no. 8), is written (after lead-in area 11 of the second session). This contains an ISO 9660 XA track that contains the pre-determined Segment Items (still pictures) and a directory named PICTURES. The PICTURES directory contains the original photos. This second session can be written by a photo finisher. The disc is now closed and lead-out area 13 is created so that no more sessions are appendable.

In this manner, the present invention provides for a simple method of combining Picture CD and Video CD (or Super Video CD) functionality. There are also other methods according to the present invention.

An additional description of the methodology of Example 1 is as follows:

Method 1

1. Place all required folders and files for Video CD in the first session with a Play Sequence Descriptor (PSD) for a pre-determined number of Segment Play Items. Modify First Segment Address in INFO.VCD file so that it points to the starting sector of ITEM0001.DAT file in SEGMENT directory. Place all necessary files including auto-run file to execute a slide show on a PC.

2. Create a Picture CD master disc by utilizing Kodak CD-PROM technology.

3. Place a pre-determined ITEMxxxx.DAT files in the first track of the second session. Be sure those files are placed in the beginning of the track, i.e., fixed locations relative to the first session. Each file occupies 150 Model Form2 sectors.

4. Place original pictures in the first track of the second session.

5. If the original pictures are less than the pre-determined numbers, place a dummy picture in the unfilled places. It can be a set of promotional pictures.

Session 1 Track 1: ISO 9660 XA CD-Bridge track that contains Picture CD files and pVCD Engine.

Session 1 Track 2: Dummy AVSEQ track.

The first session is closed. This is the image Kodak will press as a Picture CD Volume xx Issue yy.

Session 2 Track 1: ISO 9660 XA track that contains the pre-determined Segment Items (still pictures) and a directory PICTURES. PICTURES directory contains the original photos. The second session is written by a photo finisher. The disc is now closed so that no more session is appendable.

### EXAMPLE 2

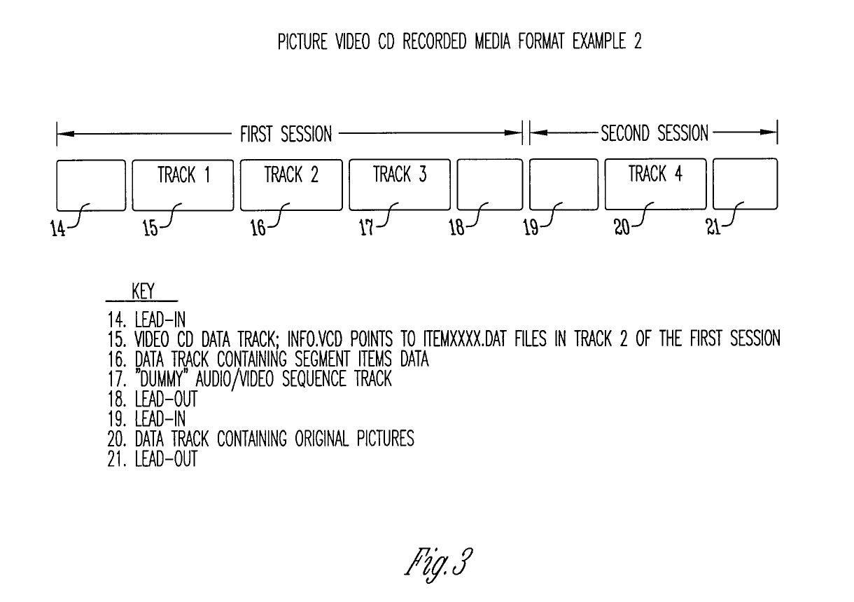

### FIG. 3

In another method according to the present invention, the same procedures as the previous method are used, but the layout of the CD's tracks differs. In this method, session 1, track 1 (ref. no. 15 of FIG. 3, after lead in area 14) is an ISO 9660 XA CD-Bridge track that contains Picture CD files and the pVCD Engine. Kodak makes this as CD-PROM. Session 1, TRACK 2 (ref. no. 16 of FIG. 3) is a dynamic pre-determined number of Segment Items. Session 1, TRACK 3 (ref. no. 17) is a dummy AVSEQ track. TRACKS 2 and 3 (ref. nos. 16 and 17) may be written by a photo finisher, then the first session is closed.

Session 2, first track (“TRACK 4”, ref. no. 20 of FIG. 3), is an ISO 9660 XA track that contains a directory named PICTURES. The PICTURES directory contains the original photos. The session 2, first track (ref. no. 20) may be written by a photo finisher. Once this track is written, the disc is now closed so that no more sessions are appendable.

This method provides for a dynamic number of pre-determined segment items. This number of pre-determined segment items can be the number of items on a single roll of film (i.e. 24 or 36) or other convenient number.

An additional description of the methodology of Example 2 is as follows:

Method 2

This method uses the same procedures with Method 1 but lays out the disc tracks differently.

Session 1 Track 1: ISO 9660 XA CD-Bridge track that contains Picture CD files and pVCD Engine. Kodak makes this as CD-PROM.

Session 1 Track 2: Dynamic pre-determined number of Segment Items.

Session 1 Track 3: Dummy AVSEQ track.

The Track 2 and 3 are written by a photo finisher, then the first session is closed. Session 2 Track 1: ISO 9660 XA track that contains a directory PICTURES. PICTURES directory contains the original photos.

The Session 2 Track 1 is written by a photo finisher. The disc is now closed so that no more session is appendable.

### EXAMPLE 3

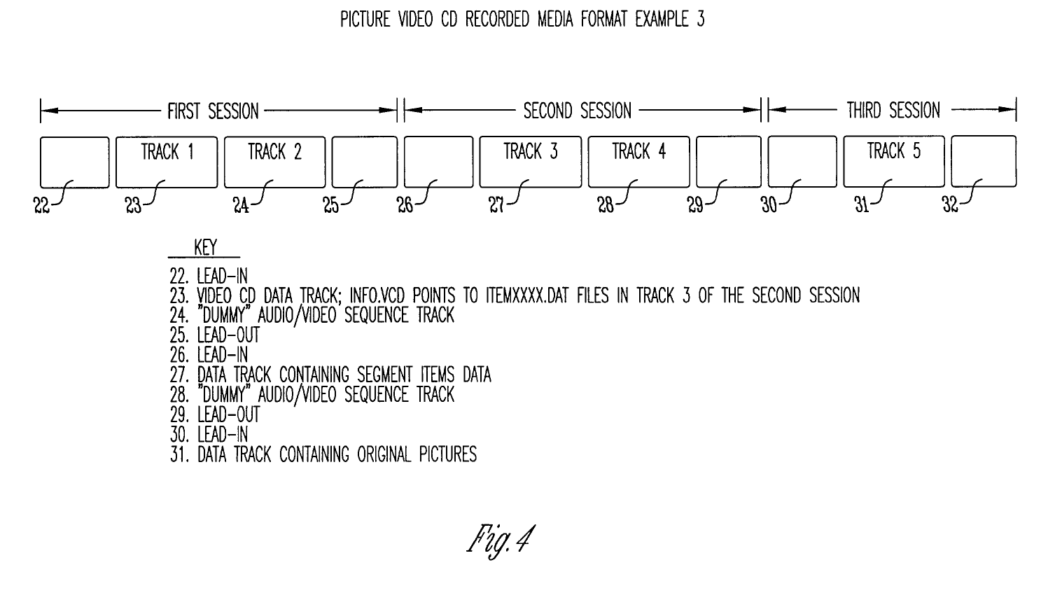

### FIG. 4

Another method according to the present invention provides for a different layout of the CD tracks. In this alternative, session 1, TRACK1 (FIG. 4, ref. no. 23) is an ISO 9660 XA CD-Bridge track that contains Picture CD files and the pVCD Engine. Next, in session 1, TRACK 2 (ref. no. 24), a dummy AVSEQ track is placed. The first session is then closed. This is the image pressed as a Picture CD Volume xx Issue yy.

Next, session 2, first track (“TRACK 3”, ref. no. 27 of FIG. 4) is an ISO 9660 XA track that contains a pre-determined number of Segment Items (still pictures). The directory record links to the first session. Next, session 2, second track (“TRACK 4”, ref. no. 28) contains a dummy AVSEQ track in the first session. The second session is then closed. Next, session 3 is written. Session 3, first track (“Track 5”, ref. no. 31) is an ISO 9660 XA track that contains a directory named PICTURES. The PICTURES directory contains the original photos. The directory record links to the first and second sessions. The second and third sessions can be written by a photo finisher. The disc is then closed so that no more sessions can be appended.

An additional description of the methodology of Example 3 is as follows:

Method 3

This method uses the same procedures with Method 1 but lays out the disc tracks differently. Session 1 Track 1: ISO 9660 XA CD-Bridge track that contains Picture CD files and pVCD Engine.

Session 1 Track 2: Dummy AVSEQ track in the first session. The first session is closed. This is the image Kodak will press as a Picture CD Volume xx Issue yy.

Session 2 Track 1: ISO 9660 XA track that contains the predetermined number of Segment Items (still pictures). The directory record links to the first session.

Session 2 Track 2: Dummy AVSEQ track in the first session. The second session is closed. Session 3 Track 1: This is an ISO 9660 XA track that contains a directory PICTURES.

PICTURES directory contains the original photos. The directory record links to the first and second sessions.

The second and third sessions are written by a photo finisher. The disc is now closed so that no more session is appendable.

### EXAMPLE 4

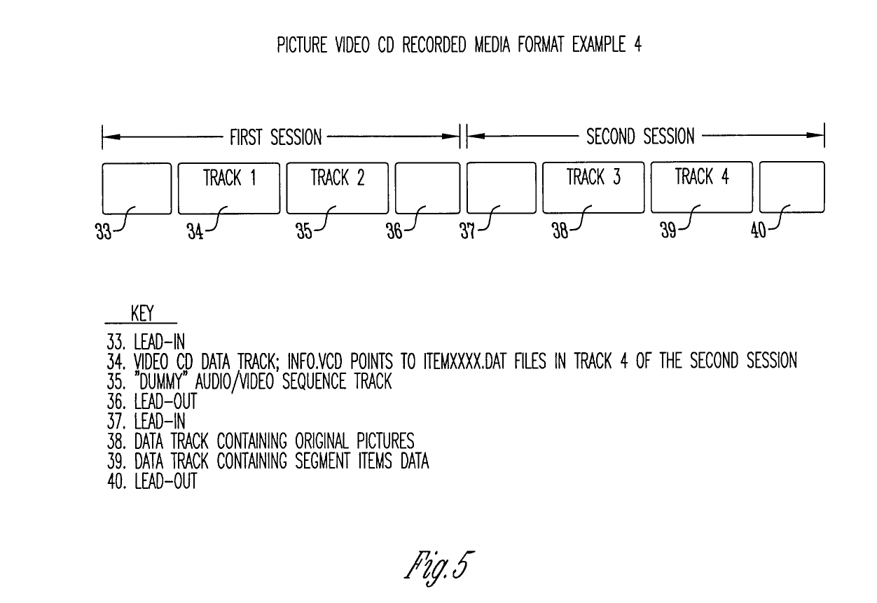

### FIG. 5

Other methods according to the present invention may also be used. For example, session 1, first track (“TRACK 1”, ref. no. 34 of FIG. 5) is an ISO 9660 XA CD-Bridge track that contains Picture CD files and the pVCD Engine. Session 1, TRACK 2 (ref. no. 35) is then a dummy AVSEQ track placed in the first session. The first session is then closed. This is the image that can be pressed as a Picture CD Volume xx Issue yy. Next, in session 2, first track (“TRACK 3”, ref. no. 38), is first reserved to a pre-determined size. Then an ISO 9660 XA track image that contains a directory named PICTURES is written. The PICTURES directory contains the original photos. In session 2, a second track (“TRACK 4”, ref. no 39), an ISO 9660 XA track that contains the pre-determined number of Segment Items (still pictures) is written. The second session may be written by a photo finisher. The disc is then closed so that no more sessions can be appended.

An additional description of the methodology of Example 4 is as follows:

Method 4

This method uses the same procedures with Method 1 but lays out the disc tracks differently.

Session 1 Track 1: ISO 9660 XA CD-Bridge track that contains Picture CD files and pVCD Engine.

Session 1 Track 2: Dummy AVSEQ track in the first session. The first session is closed. This is the image Kodak will press as a Picture CD Volume xx Issue yy.

Session 2 Track 1: The Track 1 is first reserved to a pre-determined size. Then an ISO 9660 XA track image that contains a directory PICTURES is written. PICTURES directory contains the original photos.

Session 2 Track 2: ISO 9660 XA track that contains the pre-determined number of Segment Items (still pictures).

The second session is written by a photo finisher. The disc is now closed so that no more session is appendable.

Options, Alternatives, Features

The present invention further provides for variations in the time intervals between slides. For example, the time interval currently used with Picture CD is fixed at three seconds. As the present invention provides for more than 40 slides to be put on a single CD, this time interval may be too long. For example, where there are 200 pictures on the CD, it takes 10 minutes to loop through all 200 pictures. The present invention further provides for adjusting the amount of time in accordance with the number of pictures, or as otherwise is desirable or appropriate.

In addition to the novel format of the CD, the present invention also includes a system for creating a single CD capable of use as both a Picture CD and a Video CD. The system includes a Picture CD Master (pVCD). This is a master disc which is an open session CD-Bridge disc. The pVCD components are in the first track of this disc. The first track can be pressed as a CD-PROM.

The present invention contemplates that the system may include one or more master discs. For example, one master disc may be used for 24 exposure film, one for 36 exposure film, and one for 200 slides, such as may be obtained from a digital camera. The number of slides may be greater than the number of exposures. For example, where there are 24 exposures, 30 slides may be used to provide for promotional slides, title slides, or other slides in additional to the picture images. Similarly, where 36 exposure film is used, 40 slides may be used.

The system also includes Picture CD Maker (pVCDmaker) that is a software component that can be used by photo finishers or others to add pictures to a CD. This software can add the slide show to the second track and add the photos to the second session. This software can also implement one of the alternative embodiments of the methods according to the invention.

The software uses the pVCD API. This includes an MPEG1 or MPEG2 encoder, a VCD imager, and an eDI engine. The MPEG encoder coverts the JPEG images of the Picture CD into the MPEG1 Intra-picture format for Video CD format. Where Super Video CD format is desired, then an MPEG2 encoder is used. The VCD imager creates the pVCD components to place on the CD. The eDI engine includes general CD-R/RW writing functions.

As should be apparent from the preceding description, the present invention contemplates numerous variations in the methodology used that allows Picture CD and Video CD or Super Video CD to coexist on a single CD. Additional disclosure concerning the present invention is contained within Appendix 1. The present invention contemplates these and other variations within the spirit and scope of the invention.

For example, the exemplary embodiments have been discussed relative to displacing the Video or Super Video CD Segment Items from the Video CD DATA track or track 1. Alternatively, at least in some embodiments, the displacement could be from the first session, or an early session relative the CD. For example, the rule could be that the Segment Items are displaced to another track in another session, as opposed to merely another track whether or not in the same session.

What is claimed is:

1. A method of creating an optical disc recorded media that will play back on both DVD players and personal computers, comprising recorded formats corresponding to FIG. 2, FIG. 3, FIG. 4 or FIG. 5; having Video CD Segment Items displaced from the Video CD data track 1.

2. An optical disc recorded media created by the method of claim 1.

3. The optical disc of claim 2 wherein the disc is a compact disc (CD).

4. The optical disc of claim 2 wherein the disc is a DVD.

5. The optical disc of claim 2 having a first track in a first session, wherein the first track of the first session of the optical recorded media comprises a Video CD data track format.

6. The optical disc of claim 2 having a first track in a second session, wherein the first track of the second session is a data track defined by ISO 9660 and contains original pictures to be played on a personal computer.

7. The optical disc of claim 2 having a first track in a third session, wherein the first track of the third session is a data track defined by ISO 9660 and contains original pictures to be played on a personal computer.

8. The optical disc of claim 2 having a first track in a second session, wherein the first track of the second session contains Video CD Segment Items to be played on DVD players.

9. The optical disc of claim 2 having a second track in a first session, wherein the second track of the first session contains Video CD Segment Items to be played on DVD players.

10. The optical disc of claim 2 having a second track in a second session, wherein the second track of the second session contains Video CD Segment Items to be played on DVD players.

11. The optical disc of claim 2 wherein the first track is pre-pressed.

12. The optical disc of claim 12 wherein the first track contains information from which the location of the Video CD Segment Items can be derived.

13. The optical disc of claim 2 wherein the first track contains software adapted to read Picture CD data on a personal computer.

14. A method for creating an optical disc recorded media that will play back on both DVD players and personal computers, comprising recorded formats and Video CD Segment Items displaced from a first session of the Video CD.

15. An optical disc recorded media that will play back on both DVD players and personal computers, comprising recorded formats having Video CD Segment Items displaced from the first session of the Video CD.

16. The disc of claim 15 wherein the Video CD Segment Items are displaced from the first Video CD track.
